(19) United States
(12) Patent Application Publication
(10) Pub. No.: US 2026/0189661 A1
(43) Pub. Date: Jul. 2, 2026

(54) IMAGE READING APPARATUS

(71) Applicant: SHARP KABUSHIKI KAISHA, Sakai City (JP)

(72) Inventor: HIDEYUKI HIRO, Sakai City (JP)

(21) Appl. No.: 19/414,009

(22) Filed: Dec. 9, 2025

(30) Foreign Application Priority Data
Dec. 26, 2024 (JP) 2024-230926

(51) Int. Cl. H04N 1/00

(52) U.S. Cl. CPC H04N 1/00037; H04N 1/00013; H04N 1/0005; H04N 1/00074; H04N 1/00082; H04N 1/0009; H04N 2201/0081; H04N 2201/0094

(57) ABSTRACT

An image reading apparatus that includes an operation acceptor that accepts a command from a user, an image data acquirer that reads a document and acquires image data, a contamination detector that detects contamination of the image data acquirer, a storage that records a detection result of the contamination detector as contamination detection information, a display that displays various types of information to the user, and one or more controllers, wherein in a case where the operation acceptor accepts a command to read the document, the one or more controllers refer to the contamination detection information recorded in the storage, and in a case where contamination is detected on the image data acquirer, cause the display to display a message about the contamination and an inquiry about whether to start reading of the document or not, and in a case where the operation acceptor accepts a command to start the reading of the document, cause the image data acquirer to start the reading of the document, and on the other hand, in a case where contamination is not detected on the image data acquirer, the one or more controllers cause the image data acquirer to start the reading of the document.

### DESCRIPTION

### FIELD OF THE INVENTION

The disclosure relates to an image reading apparatus, and more particularly, to an image reading apparatus having a function of detecting contamination of a document reader.

### BACKGROUND ART

In the related art, there are known image reading apparatuses such as scanners that have a contamination detection function of detecting contamination of a document reader and notifying a user of the contamination, and that have a correction function of removing contamination from read image data.

As an apparatus having such a contamination detection function, there has been known an image processing apparatus of the related art including an image storage device that reads a non-image portion before reading a document or at predetermined timing, and temporarily stores an image of a plurality of lines, an abnormal pixel detection device that detects an abnormal pixel from the image of the plurality of lines, an abnormal pixel correction device that corrects information missing due to the abnormal pixel at the time of reading the document.

It also includes an image quality correction device that performs image quality correction on an image to be corrected.

### SUMMARY

### Technical Problem

In an image reading apparatus having such a contamination detection function, in a case where a non-image portion is read when a job such as scanning is started, and the contamination detection is performed, feeding of a document cannot be started before the detection is completed, and thus there is a problem that a job start time (First Copy/Out Time (FCOT)) is delayed.

The disclosure has been made in view of the above circumstances, and an object thereof is to provide an image reading apparatus capable of accurately detecting contamination of an image data acquirer without causing a delay before a job is started as compared with the related art.

### Solution to Problem

The disclosure provides an image reading apparatus that includes an operation acceptor that accepts a command from a user, an image data acquirer that reads a document and acquires image data, a contamination detector that detects contamination of the image data acquirer, a storage that records a detection result of the contamination detector as contamination detection information, a display that displays various types of information to the user, and one or more controllers, wherein in a case where the operation acceptor accepts a command to read the document, the one or more controllers refer to the contamination detection information recorded in the storage, and in a case where contamination is detected on the image data acquirer, cause the display to display a message about the contamination and an inquiry about whether to start reading of the document or not, and in a case where the operation acceptor accepts a command to start the reading of the document, cause the image data acquirer to start the reading of the document, and on the other hand, in a case where contamination is not detected on the image data acquirer, the one or more controllers cause the image data acquirer to start the reading of the document.

### Advantageous Effects of Disclosure

According to the disclosure, it is possible to achieve an image reading apparatus capable of accurately detecting contamination for an image data acquirer without causing a delay before a job is started as compared with the related art.

### BRIEF DESCRIPTION OF THE DRAWINGS

FIG. 1 is a perspective view illustrating an external appearance of a digital multifunction apparatus including an image reading apparatus of the disclosure.

FIG. 2 is a block diagram illustrating a schematic formation of the digital multifunction apparatus in FIG. 1.

FIG. 3A and FIG. 3B are exploded perspective views illustrating a schematic formation of an image data acquirer of the digital multifunction apparatus illustrated in FIG. 1.

FIG. 4 is a flowchart illustrating one example of contamination detection processing for the image data acquirer of the digital multifunction apparatus in FIG. 1.

FIG. 5 is an explanatory diagram illustrating one example of a contamination detection setting screen of the image data acquirer displayed on a display of the digital multifunction apparatus in FIG. 1.

FIG. 6 is an explanatory diagram illustrating one example of a contamination detection message displayed on the display of the digital multifunction apparatus in FIG. 1.

FIG. 7A and FIG. 7B are explanatory diagrams illustrating one example of the operation of the image data acquirer of the digital multifunction apparatus in FIG. 1.

FIG. 8A and FIG. 8B are each an explanatory diagram showing an example of a contamination detection result for the image data acquirer of the digital multifunction apparatus in FIG. 1.

FIG. 9A and FIG. 9B are each an explanatory diagram showing an example in which a contamination state changes due to opening/closing of a document cover, for example, of an image data acquirer of a digital multifunction apparatus of the related art.

FIG. 10 is a block diagram illustrating a schematic formation of a digital multifunction apparatus of Embodiment 2 of the disclosure.

FIG. 11 is a flowchart illustrating one example of contamination detection processing for an image data acquirer of the digital multifunction apparatus of Embodiment 2 of the disclosure.

FIG. 12 is a flow chart illustrating implementation processing of the initial operation after the digital multifunction apparatus of Embodiment 2 of the disclosure is started.

FIG. 13 is a flow chart illustrating job start determination processing in a waiting state for the digital multifunction apparatus of Embodiment 2 of the disclosure.

FIG. 14 is a flowchart illustrating one example of contamination detection processing for an image data acquirer of a digital multifunction apparatus of Embodiment 3 of the disclosure.

FIG. 15 is a flow chart illustrating implementation processing of the initial operation after the digital multifunction apparatus of Embodiment 3 of the disclosure is started.

FIG. 16 is a flow chart illustrating job start determination processing in the waiting state for the digital multifunction apparatus of Embodiment 3 of the disclosure.

### DESCRIPTION OF EMBODIMENTS

Furthermore, preferred aspects of the disclosure will be described.

In the disclosure, an "image reading apparatus" is an apparatus that reads a document image and outputs image data, such as a scanner having a scanning function.

In the image reading apparatus according to the disclosure, the one or more controllers may, after the reading of the document is completed, cause the contamination detector to detect contamination of the image data acquirer, and to record a detection result in the storage as contamination detection information.

In this way, since the contamination detector is caused to detect the contamination of the image data acquirer after the reading of the document is completed, it is possible to achieve an image reading apparatus capable of accurately detecting the contamination of the image data acquirer without causing a delay before a job is started as compared with the related art.

In the image reading apparatus according to the disclosure, the one or more controllers may, after the reading of the document is completed, in a case where a predetermined contamination detection condition is satisfied, cause the contamination detector to detect contamination of the image data acquirer, and to record a detection result in the storage as contamination detection information.

In this way, since the contamination detector is caused to detect the contamination of the image data acquirer when the predetermined contamination detection condition is satisfied after the reading of the document is completed, it is possible to achieve an image reading apparatus capable of appropriately coping with a change in a contamination state, and accurately detecting the contamination of the image data acquirer without causing a delay before a job is started as compared with the related art.

In the image reading apparatus according to the disclosure, the one or more controllers may determine that the contamination detection condition is satisfied in a case where the apparatus is started or transitions to a power saving state.

In this way, since the contamination detector is caused to detect the contamination of the image data acquirer when the apparatus is started or transitions to the power saving state, it is possible to achieve an image reading apparatus capable of appropriately coping with a change in the contamination state when the apparatus is in a power OFF state or the power saving state, and accurately detecting the contamination of the image data acquirer without causing a delay before a job is started as compared with the related art.

In the image reading apparatus according to the disclosure, the one or more controllers may determine that the contamination detection condition is satisfied in a case where a predetermined time elapses from a previous detection time of contamination of the image data acquirer.

In this way, since the contamination detector is caused to detect the contamination of the image data acquirer when the predetermined time elapses from the previous detection time of the contamination of the image data acquirer, it is possible to achieve an image reading apparatus capable of appropriately coping with a change in the contamination state due to the elapse of time, and accurately detecting the contamination of the image data acquirer without causing a delay before a job is started as compared with the related art.

In the image reading apparatus according to the disclosure, the image data acquirer may include a document table on which the document is placed, a document cover, and an opening/closing detector of the document cover, and the one or more controllers may determine that the contamination detection condition is satisfied in a case where opening/closing of the document cover is detected.

In this way, since the contamination detector is caused to detect the contamination of the image data acquirer when the opening/closing of the document cover is detected, it is possible to achieve an image reading apparatus capable of appropriately coping with a change in the contamination state due to the opening/closing of the document cover, and accurately detecting the contamination of the image data acquirer without causing a delay before a job is started as compared with the related art.

Hereinafter, the disclosure will be described in further detail using the drawings. Note that the following description is illustrative in all aspects and it should not be understood as limiting the disclosure.

### Embodiment 1

### Formation of Digital Multifunction Apparatus 1 of Embodiment 1 of Disclosure

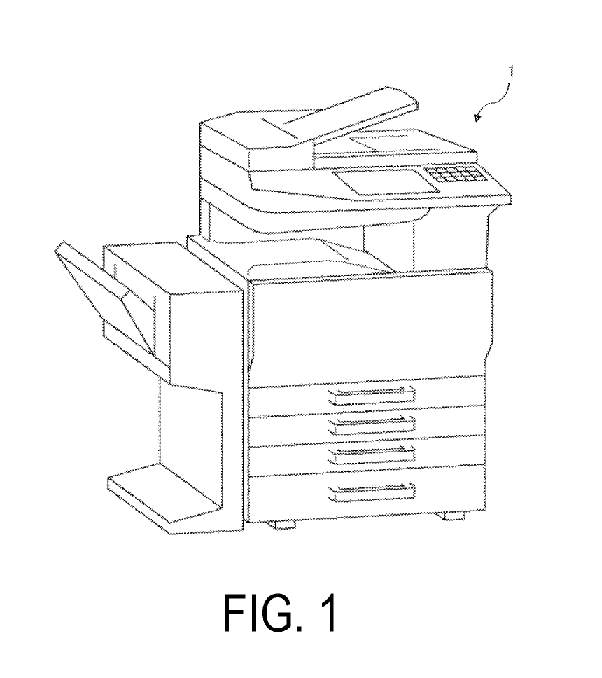

Hereinafter, an overview of a digital multifunction apparatus 1 as one example of an image forming apparatus including an image reading apparatus of the disclosure will be described based on FIG. 1 to FIGS. 3A and 3B.

FIG. 1 is a perspective view illustrating an external appearance of the digital multifunction apparatus 1 of Embodiment 1 of the disclosure.

The digital multifunction apparatus 1 has a copy function, a scanner function, and a facsimile function, and is an apparatus that digitally processes image data read from a document and outputs the processed image data.

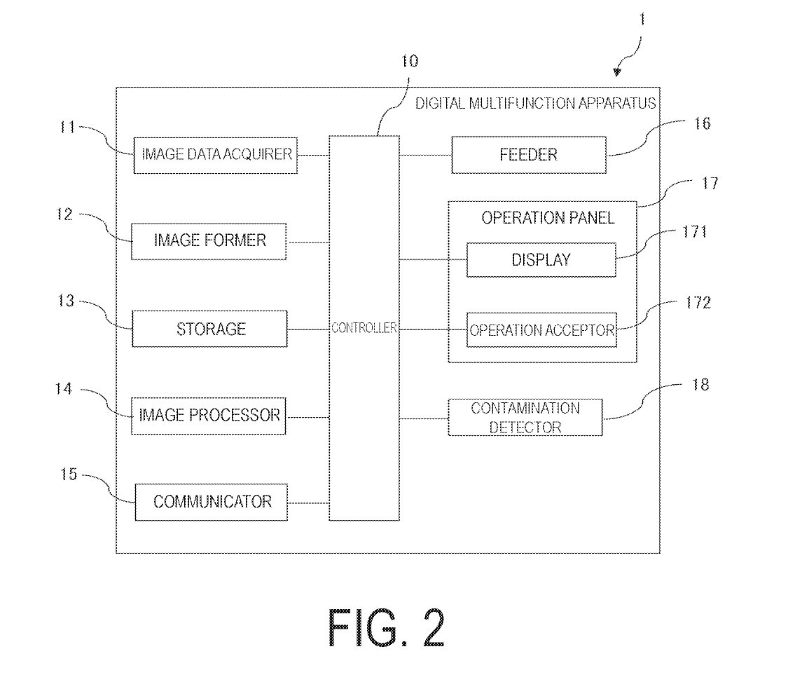

Next, a schematic formation of the digital multifunction apparatus 1 will be described based on FIG. 2.

FIG. 2 is a block diagram illustrating a schematic formation of the digital multifunction apparatus 1 in FIG. 1.

As illustrated in FIG. 2, the digital multifunction apparatus 1 includes a controller 10, an image data acquirer 11, an image former 12, a storage 13, an image processor 14, a communicator 15, a feeder 16, an operation panel 17, and a contamination detector 18.

Hereinafter, each constituent element of the digital multifunction apparatus 1 will be described.

The controller 10 collectively controls the digital multifunction apparatus 1 and includes at least one Central Processing Unit (CPU), at least one Random Access Memory (RAM), at least one Read Only Memory (ROM), various interface circuits, and the like.

The controller 10 monitors and controls all loads such as detection of each sensor, a motor, a clutch, and the operation panel 17 in order to control the overall operation of the digital multifunction apparatus 1.

The image data acquirer 11 is a part that detects and optically reads a document placed on a document table or a document conveyed from a document tray to generate image data.

The image former 12 is a part that prints image data acquired by the image data acquirer 11 and processed by the image processor 14 onto a sheet to output.

The storage 13 is an element or a storage medium that stores information necessary to enable various functions of the digital multifunction apparatus 1, control programs, and the like. For example, a semiconductor element such as a RAM or a ROM or a storage medium such as a hard disk, a flash storage, or a Solid State Drive (SSD) is used.

Note that a program and data may be recorded in different apparatuses, such as by forming an area for recording data in a hard disk drive and an area for recording programs in a flash storage.

The storage 13 records a value (ON/OFF) of a contamination detection flag as information indicating whether contamination is detected on the image data acquirer 11 or not.

The image processor 14 is a part that converts image data of a document read by the image data acquirer 11 into an appropriate electrical signal based on analysis results of commands for jobs such as printing obtained from a user terminal 2 or the like, or commands for jobs such as scanning input from an operation acceptor 172, and processes the signal so as to be suitable for output such as enlargement or reduction.

The communicator 15 is a part that communicates with external devices such as the user terminal via a network, and transmits and receives data or the like to and from these external devices.

The feeder 16 includes sheet feeding cassettes and a manual feed tray, and conveys sheets stored therein to the image former 12.

The operation panel 17 is formed of a display panel formed of a liquid crystal panel or the like, and a touch panel, such as a capacitive touch panel, that is placed on top of the display panel and detects a position touched with a finger, and includes a display 171 and the operation acceptor 172.

The display 171 is a part that displays various types of information.

The display 171 is formed of, for example, a CRT display, a liquid crystal display, an EL display, or the like, and is a display apparatus such as a monitor or a line display used by an operating system, or application software to display electronic data such as processing status.

The controller 10 displays the operation and status of the digital multifunction apparatus 1 through the display 171.

The operation acceptor 172 is an interface for operating the digital multifunction apparatus 1 and is a part that receives commands from the user.

The operation acceptor 172 does not need to be operated only by a touch operation, and part or all of the operation acceptor 172 may be formed with physical keys independent of the display 171.

The contamination detector 18 is a part that detects contamination of the image data acquirer 11, and particularly detects contamination that may be erroneously read at the time of reading of a document, such as contamination of a glass surface of a document table or an opposing plate to read a document.

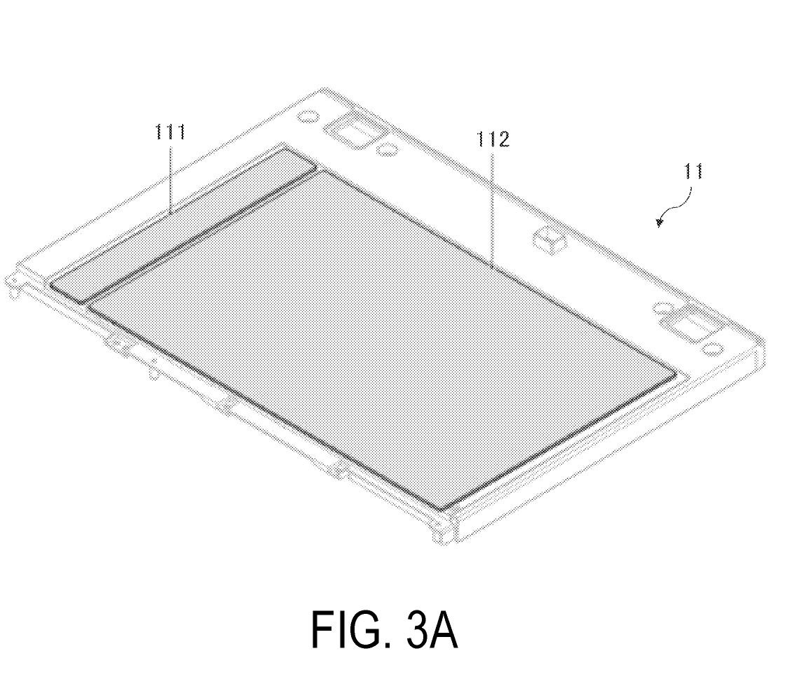

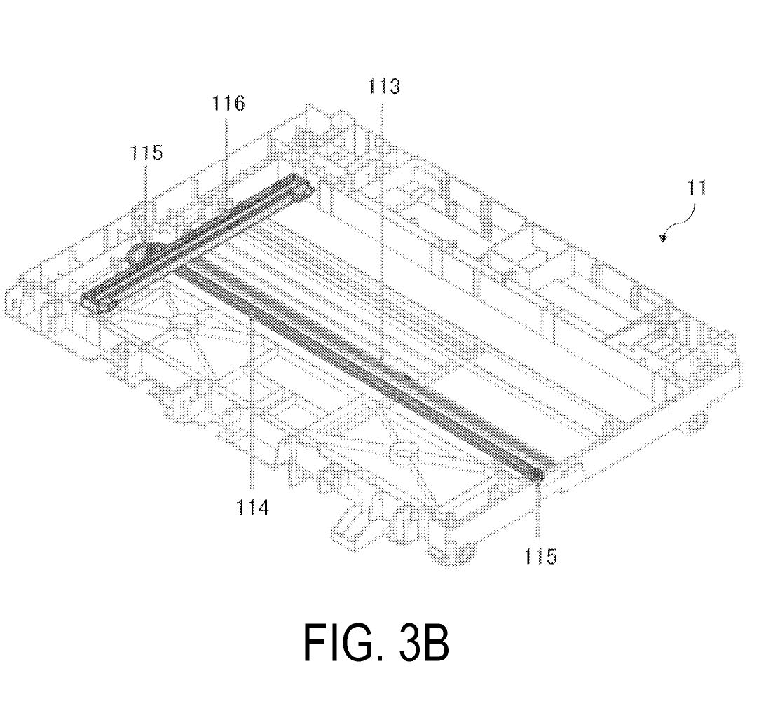

FIG. 3A and FIG. 3B are exploded perspective views illustrating a schematic formation of the image data acquirer 11 of the digital multifunction apparatus 1 illustrated in FIG. 1.

FIG. 3A illustrates the formation of the glass surface of the document table to read a document.

As illustrated in FIG. 3A, the image data acquirer 11 is provided with a document reading glass 111 to read a document conveyed by an Automatic Document Feeder (ADF) and a document placement glass 112 to place a document on the document table.

FIG. 3B illustrates the formation of a reading mechanism to optically read a document provided under the glass surface illustrated in FIG. 3A.

As illustrated in FIG. 3B, a document reading unit 116 is formed to be movable in a sub-scanning direction above a rail 113 by a drive belt 114 and a drive gear 115.

Further, the document reading unit 116 optically reads an image of a document separated and fed one at a time from the ADF.

Examples of the document reading unit 116 include a CCD reading unit including a Charge Coupled Device (CCD) sensor, a Contact Image Sensor (CIS) reading unit including a Complementary Metal Oxide Semiconductor (CMOS) sensor, and the like.

Further, the document reading unit 116 is also used to detect contamination of the glass surface or the opposing plate by the contamination detector 18, as described below.

Contamination Detection Processing for Image Data Acquirer 11 of Digital Multifunction Apparatus 1 of Embodiment 1 of Disclosure

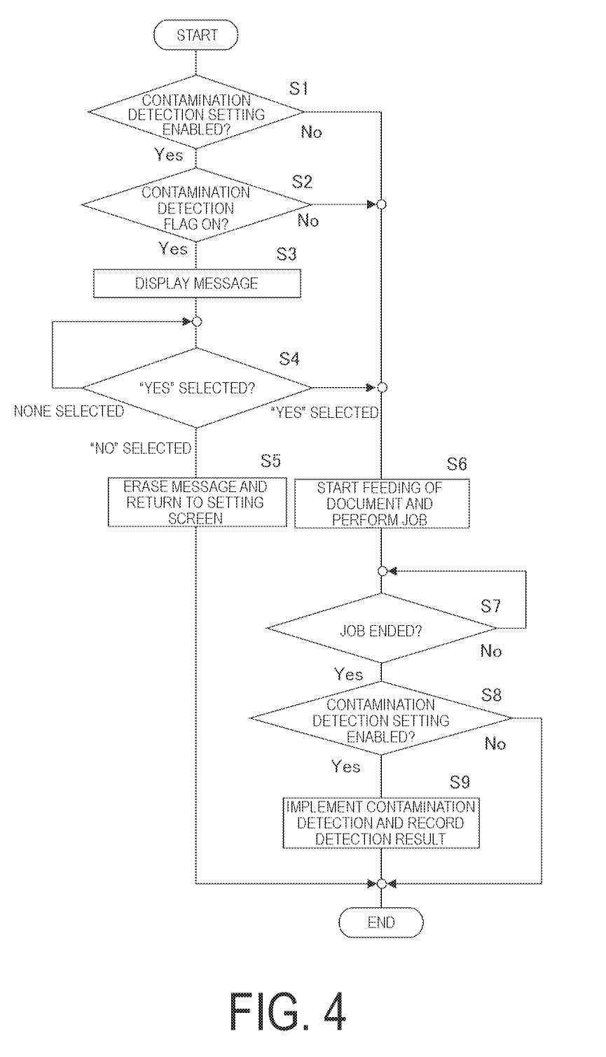

Next, contamination detection processing for the image data acquirer 11 of the digital multifunction apparatus 1 of Embodiment 1 of the disclosure will be described based on FIG. 4.

FIG. 4 is a flowchart illustrating one example of the contamination detection processing for the image data acquirer 11 of the digital multifunction apparatus 1 in FIG. 1.

In FIG. 4, a case is assumed where a job such as a scan job or a copy job is performed to form an image based on image data acquired by reading a document by the image data acquirer 11.

In this case, in step S1, the controller 10 of the digital multifunction apparatus 1 determines whether a contamination detection setting is enabled or not (step S1).

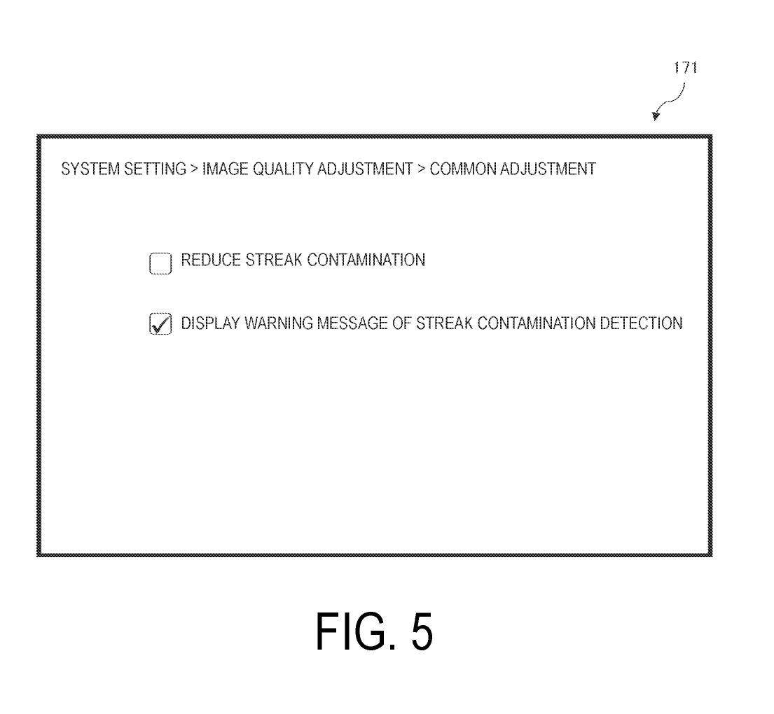

FIG. 5 is an explanatory diagram illustrating one example of a contamination detection setting screen of the image data acquirer 11 displayed on the display 171 of the digital multifunction apparatus 1 in FIG. 1.

In the example of FIG. 5, two setting items of "REDUCE STREAK CONTAMINATION" and "DISPLAY WARNING MESSAGE OF STREAK CONTAMINATION DETECTION" are displayed on a setting screen of "SYSTEM SETTING > IMAGE QUALITY ADJUSTMENT > COMMON ADJUSTMENT".

As illustrated in FIG. 5, the user can enable the contamination detection setting by checking a checkbox of the setting item of "DISPLAY WARNING MESSAGE OF STREAK CONTAMINATION DETECTION".

In step S1 of FIG. 4, when the contamination detection setting is enabled (when the determination in step S1 is YES), in step S2, the controller 10 determines whether a contamination detection flag is ON or not (step S2).

As described below, when no contamination is detected on the image data acquirer 11, the contamination detection flag remains OFF (a default value). On the other hand, when contamination is detected on the image data acquirer 11, the contamination detection flag is set to ON.

When the contamination detection flag is ON (when the determination in step S2 is YES), in step S3, the controller 10 causes the display 171 to display a predetermined message (step S3).

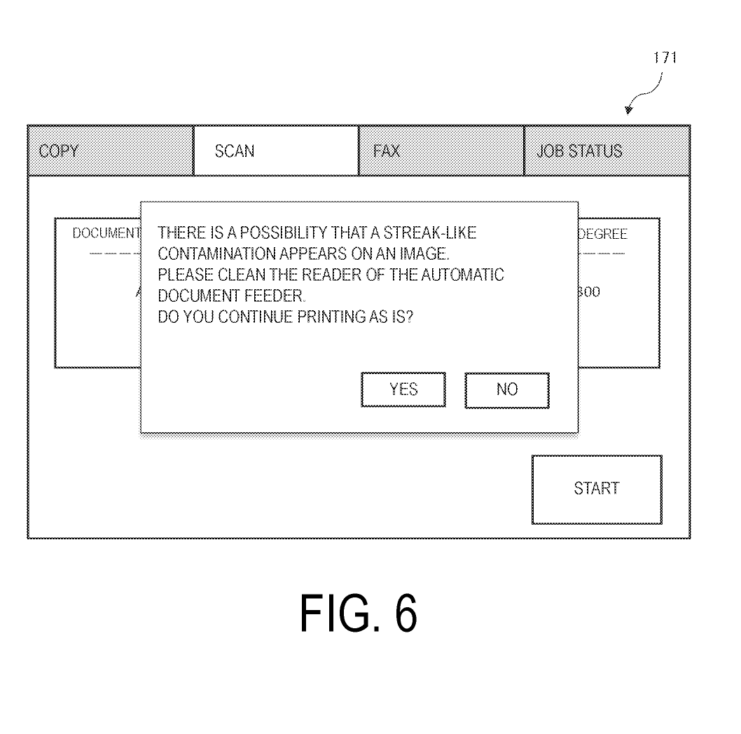

FIG. 6 is an explanatory diagram illustrating one example of a contamination detection message displayed on the display 171 of the digital multifunction apparatus 1 in FIG. 1.

In the example of FIG. 6, a message "THERE IS A POSSIBILITY THAT A STREAK-LIKE CONTAMINATION APPEARS ON AN IMAGE. PLEASE CLEAN THE READER OF THE AUTOMATIC DOCUMENT FEEDER. DO YOU CONTINUE PRINTING AS IS?" is displayed on the display 171 as a pop-up.

The user selects "YES" to continue the printing, and selects "NO" not to continue the printing.

Next, in step S4 in FIG. 4, the controller 10 determines whether either "YES" or "NO" is selected or not (step S4).

When "NO" is selected (when the determination in step S4 is "NO"), in step S5, the controller 10 causes the display 171 to erase the message to return to the original setting screen (step S5), and ends the processing.

When neither "YES" nor "NO" is selected (when the determination in step S4 is "NONE SELECTED"), the controller 10 returns the processing to the determination in step S4.

On the other hand, when "YES" is selected (when the determination in step S4 is "YES"), in step S6, the controller 10 causes the feeder 16 to start feeding a document, and causes the image former 12 to perform a job (step S6).

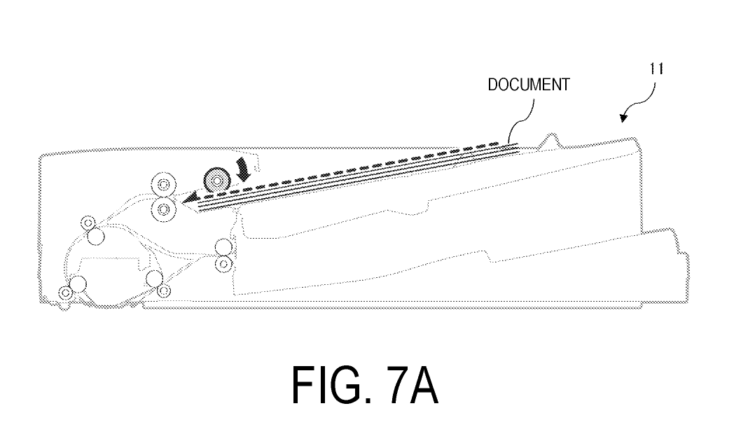

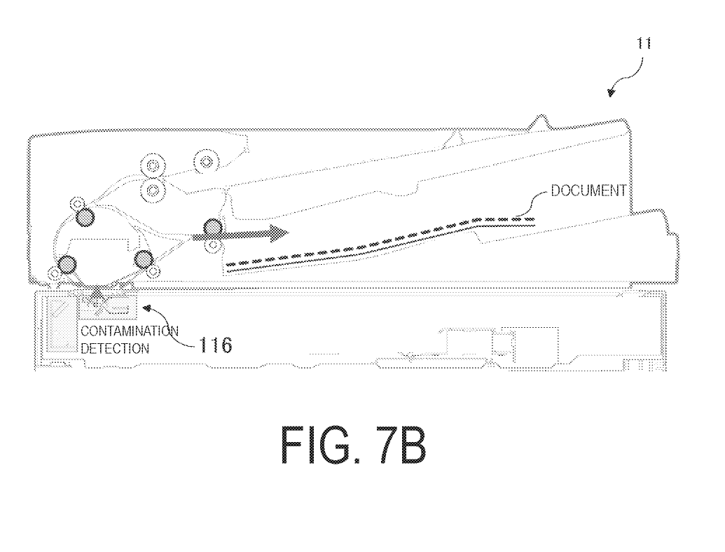

FIG. 7A and FIG. 7B are explanatory diagrams illustrating one example of the operation of the image data acquirer 11 of the digital multifunction apparatus 1 in FIG. 1.

As illustrated in FIG. 7A, when the contamination detection setting is not enabled, feeding of a document is started without performing the contamination detection.

Note that, also when the contamination detection setting is not enabled in step S1 in FIG. 4 (when the determination in step S1 is NO) and when the contamination detection flag is OFF in step S2 (when the determination in step S2 is NO), in step S6, the controller 10 causes the feeder 16 to start feeding a document and causes the image former 12 to perform a job.

Next, in step S7, the controller 10 determines whether the job is ended or not (step S7).

When the job is not ended (when the determination in step S7 is NO), the processing is returned to the determination in step S7.

On the other hand, when the job is ended (when the determination in step S7 is YES), in step S8, the controller 10 determines whether the contamination detection setting is enabled or not (step S8).

When the contamination detection setting is enabled (when the determination in step S8 is YES), in step S9, the controller 10 causes the contamination detector 18 to implement the contamination detection for the image data acquirer 11, to record a detection result in the storage 13 (step S9), and ends the processing.

When the contamination detection setting is enabled, as illustrated in FIG. 7B, the contamination detection is implemented after the feeding of the document is completed.

In a method of determining whether there is contamination or not, it is determined whether a level of a pixel obtained by reading the glass surface of the document reading glass 111 or the opposing plate with a line sensor is less than a predetermined threshold value or not in a state where the document reading unit 116 is stationary under the document reading glass 111.

Examples of the contamination of the glass surface or the opposing plate include contamination due to adhesion of paper dust. Normally, in a state where there is no document, a level of a white pixel of the opposing plate is detected. However, when contamination such as paper dust adheres to the glass surface or the opposing plate, a level of a black pixel of a portion to which the contamination adheres is smaller than the level of the pixel of the opposing plate, and thus presence or absence of the contamination can be detected by determining whether the level of the pixel is less than the predetermined threshold value or not.

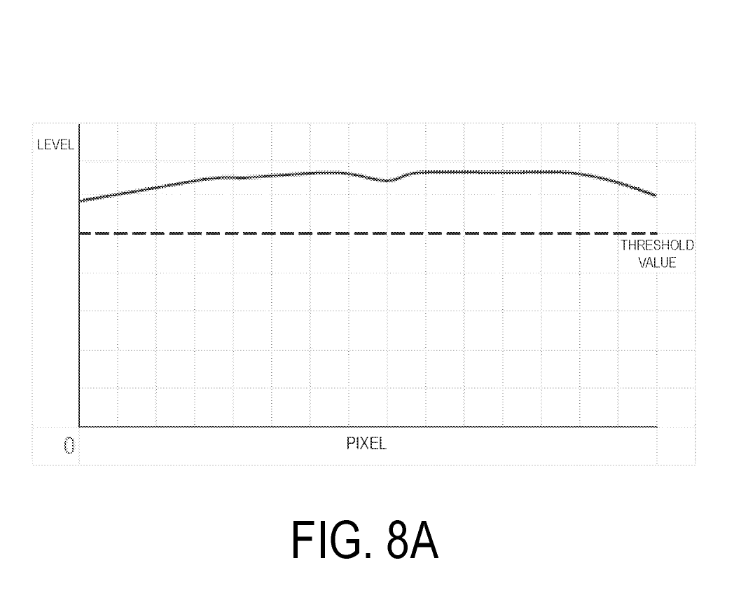

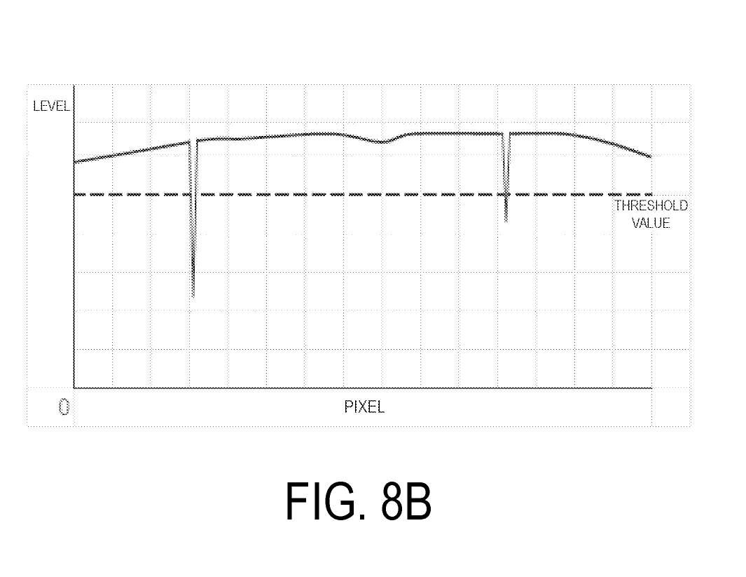

FIG. 8A and FIG. 8B are each an explanatory diagram showing an example of a contamination detection result for the image data acquirer 11 of the digital multifunction apparatus 1 in FIG. 1.

When there is no contamination of the glass surface of the document reading glass 111 or the opposing plate, as illustrated in FIG. 8A, a level of any pixel in a read area is equal to or greater than the threshold value.

In this case, the controller 10 determines that no contamination is detected, and keeps the contamination detection flag OFF (default).

On the other hand, when there is contamination of the glass surface of the document reading glass 111 or the opposing plate, a level of a pixel to which the contamination adheres falls below the threshold value as illustrated in FIG. 8B. In the example of FIG. 8B, levels of pixels at two locations are less than the threshold value.

In this case, the controller 10 determines that contamination is detected, sets the contamination detection flag to ON, and records the determination in the storage 13.

In this way, since the contamination detector is caused to detect the contamination of the image data acquirer 11 after the reading of the document is completed, it is possible to achieve the digital multifunction apparatus 1 capable of accurately detecting the contamination of the image data acquirer without causing a delay before a job is started as compared with the related art.

### Embodiment 2

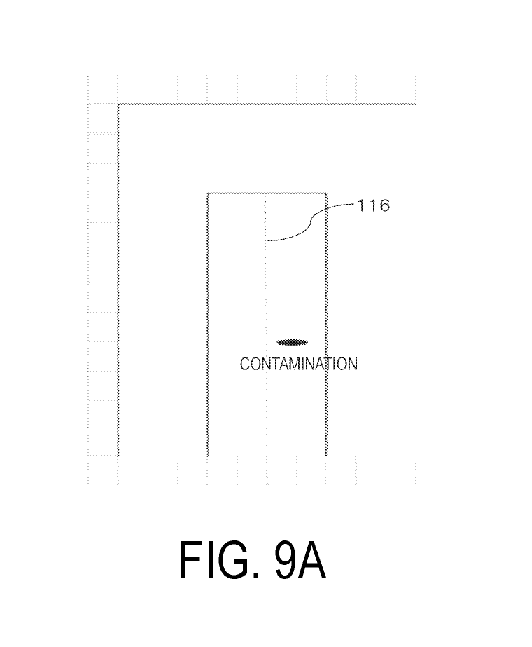

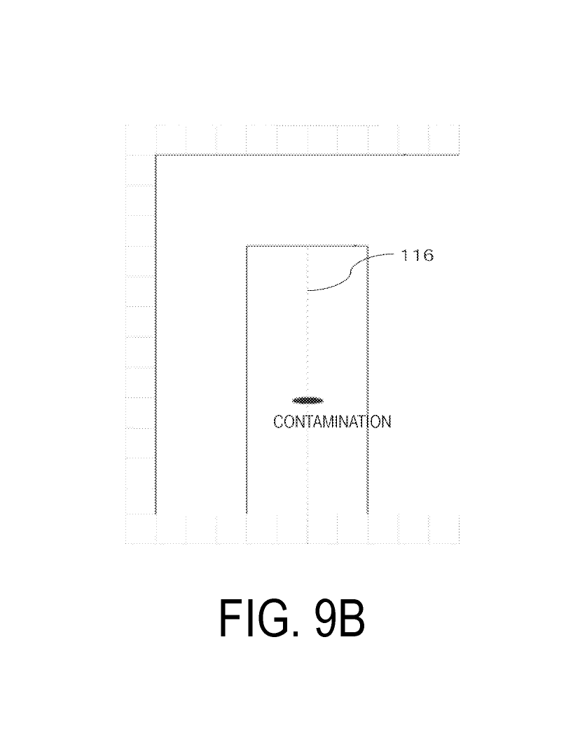

Next, contamination detection processing for the image data acquirer 11 of the digital multifunction apparatus 1 of Embodiment 2 of the disclosure will be described based on FIGS. 9A and 9B to FIG. 13.

In the digital multifunction apparatus 1, when the contamination detection is implemented after a job is ended, there is a possibility that a contamination state of the image data acquirer 11 is changed before the next job is started due to opening and closing of a document cover, for example.

FIG. 9A and FIG. 9B are each an explanatory diagram showing an example in which the contamination state changes due to opening/closing of the document cover of the image data acquirer 11 of the digital multifunction apparatus 1 of the related art, for example.

As illustrated in FIG. 9A, when contamination of the glass surface of the document reading glass 111 or the opposing plate is at a position deviated from a read area of the document reading unit 116, it is determined that there is no contamination.

However, as a result of contamination, such as paper dust adhering to the glass surface or the opposing plate, moved due to opening and closing of the document cover, for example, the contamination state may change before the next job is started as illustrated in FIG. 9B.

In the digital multifunction apparatus 1 of Embodiment 2 of the disclosure, in order to avoid the problem of the change in the contamination state, a pre-job implementation flag is set to ON under a specific condition in which the contamination state may change, and the contamination detection is implemented.

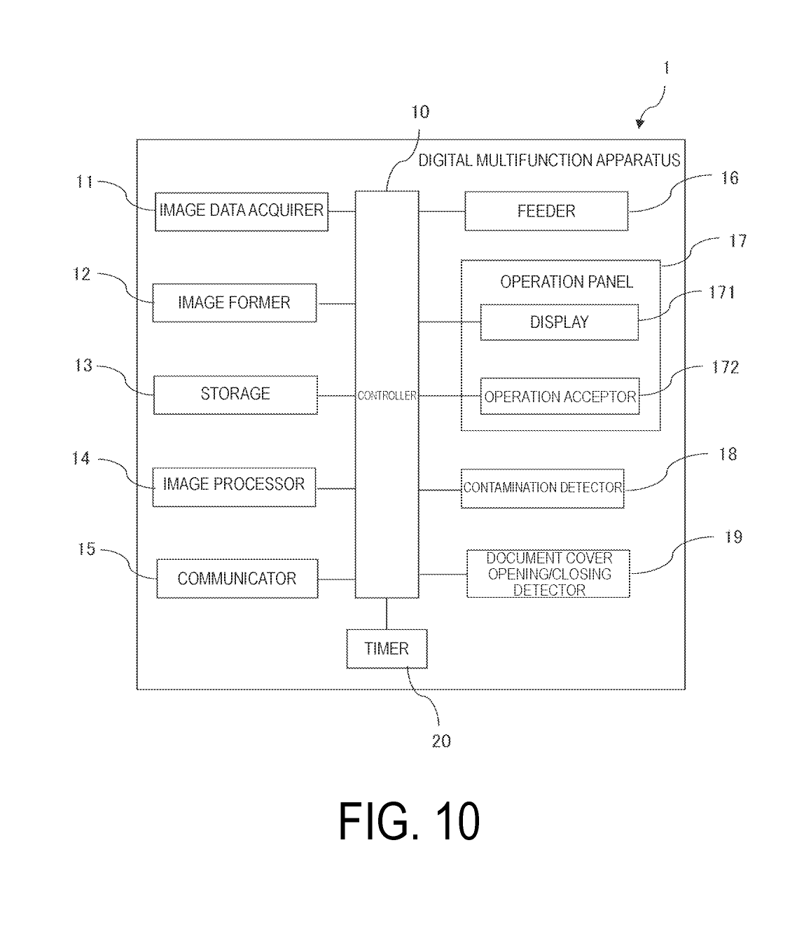

FIG. 10 is a block diagram illustrating a schematic formation of the digital multifunction apparatus 1 of Embodiment 2 of the disclosure.

In FIG. 10, a document cover opening/closing detector 19 is a sensor that detects an opening/closing state of the document cover.

A timer 20 is a part that measures and counts time and acquires, for example, a clock time via an incorporated clock or a network.

Further, in addition to the value (ON/OFF) of the contamination detection flag, the storage 13 also records the pre-job implementation flag (ON/OFF) as information indicating whether the contamination detection is to be performed before a job is started or not.

Since other formations of the digital multifunction apparatus 1 of Embodiment 2 of the disclosure are similar to the formations (FIG. 1 to FIGS. 3A and 3B) of the digital multifunction apparatus 1 of Embodiment 1 of the disclosure, description thereof will be omitted.

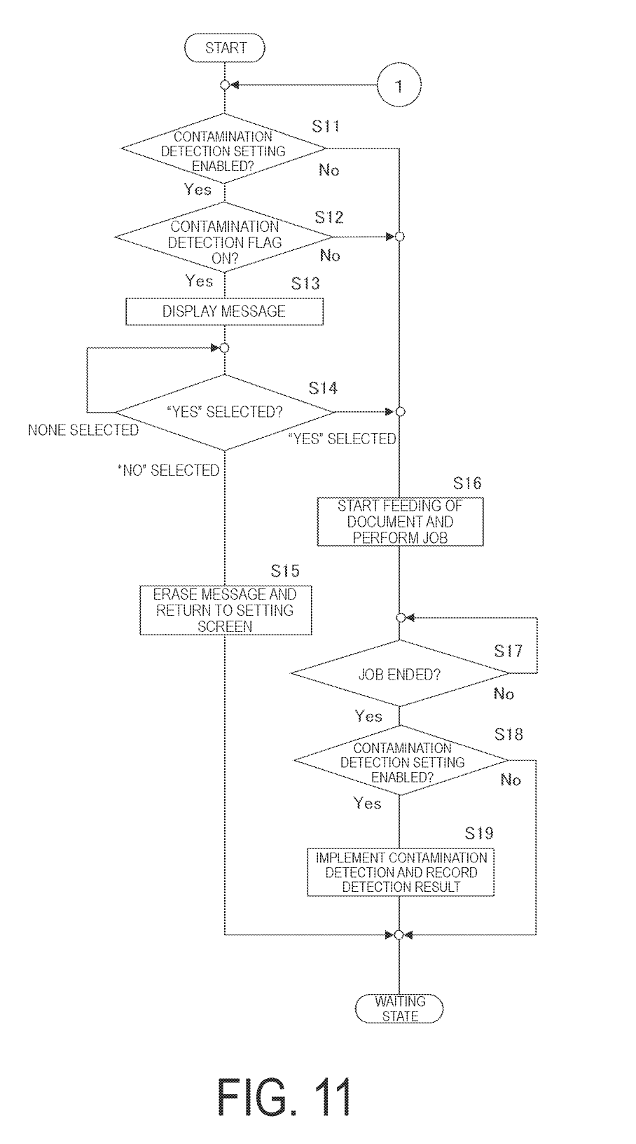

FIG. 11 is a flowchart illustrating one example of the contamination detection processing for the image data acquirer 11 of the digital multifunction apparatus 1 of Embodiment 2 of the disclosure.

In FIG. 11, similar to FIG. 4 (Embodiment 1), the case is assumed where a job such as a scan job or a copy job is performed to form an image based on image data acquired by reading a document by the image data acquirer 11.

In this case, in step S11, the controller 10 of the digital multifunction apparatus 1 determines whether the contamination detection setting is enabled or not (step S11).

When the contamination detection setting is enabled (when the determination in step S11 is YES), in step S12, the controller 10 determines whether the contamination detection flag is ON or not (step S12).

When the contamination detection flag is ON (when the determination in step S12 is YES), in step S13, the controller 10 causes the display 171 to display a predetermined message (step S13).

Next, in step S14, the controller 10 determines whether either "YES" or "NO" is selected or not (step S14).

When "NO" is selected (when the determination in step S14 is "NO"), in step S15, the controller 10 causes the display 171 to erase the message to return to the original setting screen (step S15), and causes the apparatus to transition to a waiting state.

When neither "YES" nor "NO" is selected (when the determination in step S14 is "NONE SELECTED"), the controller 10 returns the processing to the determination in step S14.

On the other hand, when "YES" is selected (when the determination in step S14 is "YES"), in step S16, the controller 10 causes the feeder 16 to start feeding a document, and causes the image former 12 to perform a job (step S16).

Note that, also when the contamination detection setting is not enabled in step S11 (when the determination in step S11 is NO) and when the contamination detection flag is OFF in step S12 (when the determination in step S12 is NO), in step S16, the controller 10 causes the feeder 16 to start feeding a document and causes the image former 12 to perform a job.

In step S17 that follows, the controller 10 determines whether the job is ended or not (step S17).

When the job is not ended (when the determination in step S17 is NO), the processing is returned to the determination in step S17.

On the other hand, when the job is ended (when the determination in step S17 is YES), in step S18, the controller 10 determines whether the contamination detection setting is enabled or not (step S18).

When the contamination detection setting is enabled (when the determination in step S18 is YES), in step S19, the controller 10 causes the contamination detector 18 to implement the contamination detection for the image data acquirer 11, and to record a detection result in the storage 13 (step S19).

Thereafter, the controller 10 causes the apparatus to transition to the waiting state.

In addition, in step S18, also when the contamination detection setting is not enabled (when the determination in step S18 is NO), the controller 10 causes the apparatus to transition to the waiting state.

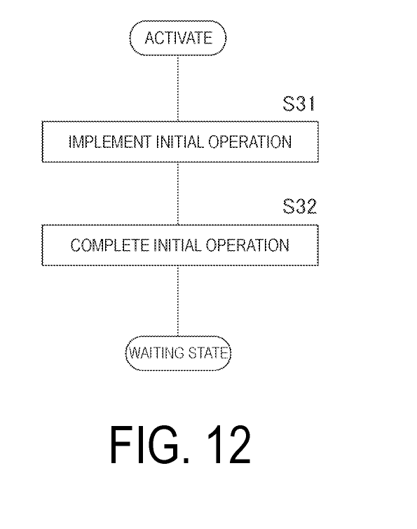

FIG. 12 is a flow chart illustrating implementation processing of the initial operation after the digital multifunction apparatus 1 of Embodiment 2 of the disclosure is started.

As illustrated in FIG. 12, after the digital multifunction apparatus 1 is started, in step S31, the controller 10 implements a predetermined initial operation (step S31).

Next, in step S32, when the predetermined initial operation is completed (step S32), the controller 10 causes the apparatus to transition to the waiting state.

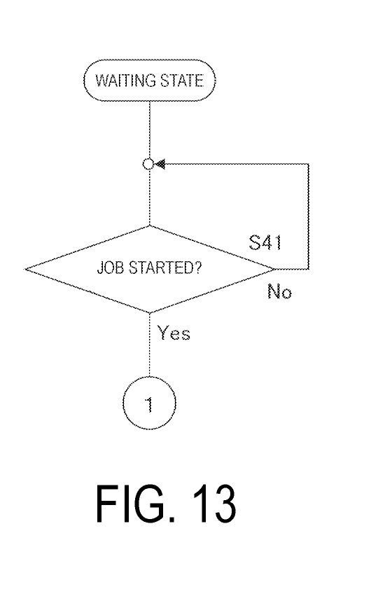

FIG. 13 is a flow chart illustrating job start determination processing in the waiting state for the digital multifunction apparatus 1 of Embodiment 2 of the disclosure.

As illustrated in FIG. 13, when the digital multifunction apparatus 1 is in the waiting state, in step S41, the controller 10 determines whether a job is started or not (step S41).

When a job is started (when the determination in step S41 is YES), the controller 10 returns the processing to the determination in step S11 in FIG. 11.

On the other hand, when a job is not started (when the determination in step S41 is NO), the controller 10 returns the processing to the determination in step S41.

In this way, since the contamination detector 18 is caused to detect contamination for the image data acquirer 11 when the predetermined contamination detection condition is satisfied after reading of a document is completed, it is possible to achieve the digital multifunction apparatus 1 capable of appropriately coping with a change in the contamination state due to opening and closing of the document cover, a change in the contamination state when the apparatus is in the power OFF state or the power saving state, and a change in the contamination state due to elapse of time, and accurately performing the contamination detection for the image data acquirer without causing a delay before a job is started as compared with the related art.

### Embodiment 3

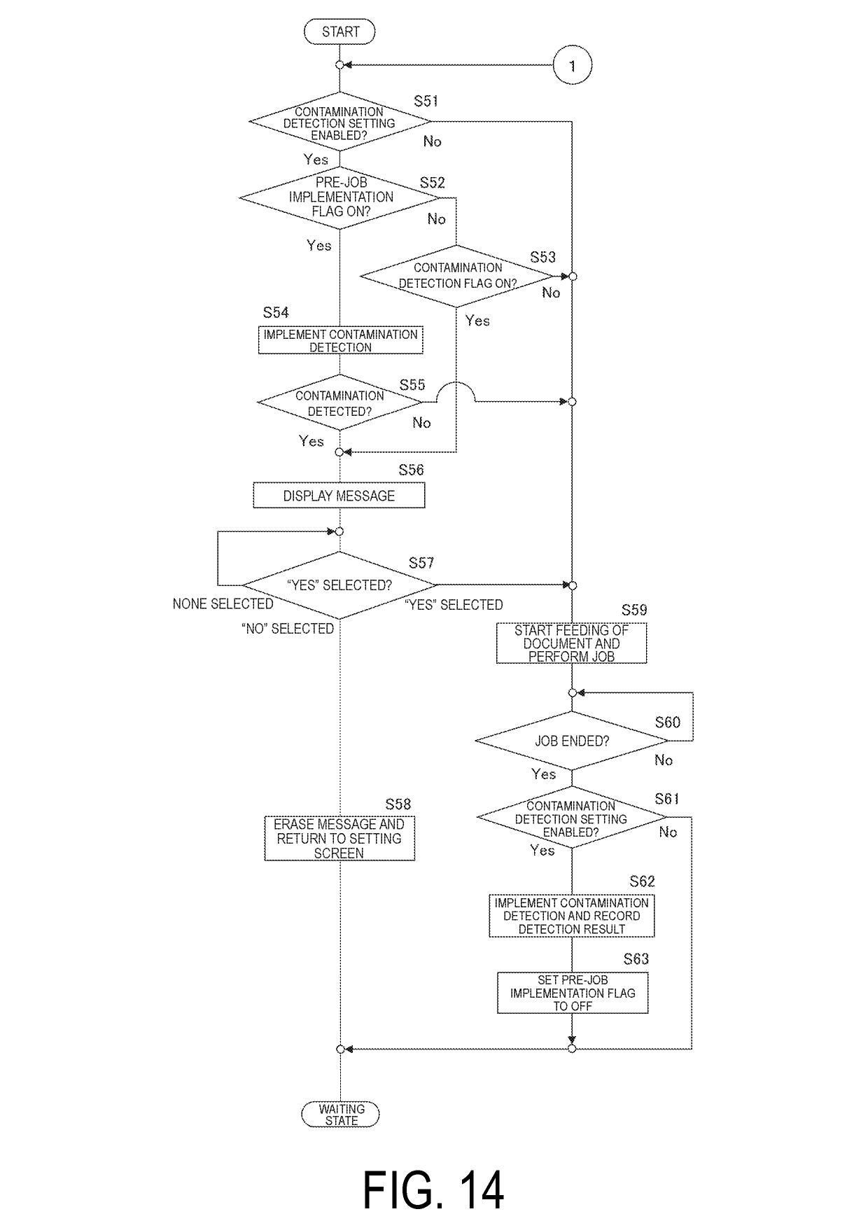

Next, contamination detection processing for the image data acquirer 11 of the digital multifunction apparatus 1 of Embodiment 3 of the disclosure will be described based on FIGS. 14 to 16.

The digital multifunction apparatus 1 of Embodiment 2 of the disclosure is characterized in that the contamination detection is implemented when the predetermined contamination detection condition is satisfied after a job is completed.

On the other hand, the digital multifunction apparatus 1 of Embodiment 3 of the disclosure is characterized in that it is easier to cope with a change in the contamination state before a job is started as compared with Embodiment 2 since the contamination detection is implemented when the predetermined contamination detection condition is satisfied before a job is started.

Formation of the digital multifunction apparatus 1 of Embodiment 3 of the disclosure is similar to the formation of Embodiment 1 of the disclosure (FIG. 1 and FIGS. 3A and 3B) and the formation of the digital multifunction apparatus 1 of Embodiment 2 (FIG. 2), and thus description thereof will be omitted.

FIG. 14 is a flowchart illustrating one example of contamination detection processing for the image data acquirer 11 of the digital multifunction apparatus 1 of Embodiment 3 of the disclosure.

In FIG. 14, similar to FIG. 4 (Embodiment 1) and FIG. 11 (Embodiment 2), the case is assumed where a job such as a scan job or a copy job is performed to form an image based on image data acquired by reading a document by the image data acquirer 11.

In this case, in step S51, the controller 10 of the digital multifunction apparatus 1 determines whether the contamination detection setting is enabled or not (step S51).

When the contamination detection setting is enabled (when the determination in step S51 is YES), in step S52, the controller 10 determines whether the pre-job implementation flag is ON or not (step S52).

When the pre-job implementation flag is not ON (when the determination in step S52 is NO), in step S53, the controller 10 determines whether the contamination detection flag is ON or not (step S53).

When the contamination detection flag is ON (when the determination in step S53 is YES), in step S56, the controller 10 causes the display 171 to display a predetermined message (step S56).

On the other hand, when the pre-job implementation flag is ON (when the determination in step S52 is YES), in step S54, the controller 10 causes the contamination detector 18 to implement the contamination detection for the image data acquirer 11 (step S54).

In step S55 that follows, the controller 10 determines whether the contamination detector 18 detects contamination or not (step S55).

When the contamination detector 18 detects contamination (when the determination in step S55 is YES), in step S56, the controller 10 causes the display 171 to display a predetermined message (step S56).

Next, in step S57, the controller 10 determines whether either "YES" or "NO" is selected or not (step S57).

When "NO" is selected (when the determination in step S57 is "NO"), in step S15, the controller 10 causes the display 171 to erase the message to return to the original setting screen (step S58), and causes the apparatus to transition to the waiting state.

When neither "YES" nor "NO" is selected (when the determination in step S57 is "NONE SELECTED"), the controller 10 returns the processing to the determination in step S57.

On the other hand, when "YES" is selected (when the determination in step S57 is "YES"), in step S59, the controller 10 causes the feeder 16 to start feeding a document, and causes the image former 12 to perform a job (step S59).

In addition, also when the contamination detection setting is OFF in step S51 (when the determination in step S51 is NO), when the contamination detection flag is OFF in step S53 (when the determination in step S53 is NO), and when contamination is not detected in step S55 (when the determination in step S55 is NO), the controller 10 causes the feeder 16 to start feeding a document and causes the image former 12 to perform a job (step S59).

Next, in step S60, the controller 10 determines whether the job is ended or not (step S60).

When the job is not ended (when the determination in step S60 is NO), the processing is returned to the determination in step S60.

On the other hand, when the job is ended (when the determination in step S60 is YES), in step S61, the controller 10 determines whether the contamination detection setting is enabled or not (step S61).

When the contamination detection setting is enabled (when the determination in step S61 is YES), in step S62, the controller 10 causes the contamination detector 18 to implement the contamination detection for the image data acquirer 11, and to record a detection result in the storage 13 (step S62).

Next, in step S63, the controller 10 sets the pre-job implementation flag to OFF (step S63), and then causes the apparatus to transition to the waiting state.

In addition, in step S61, also when the contamination detection setting is not enabled (when the determination in step S61 is NO), the controller 10 causes the apparatus to transition to the waiting state.

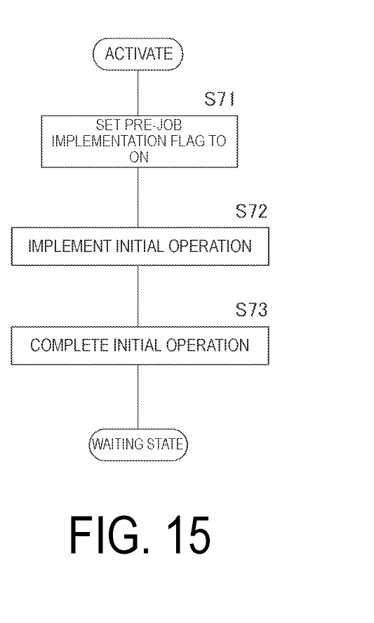

FIG. 15 is a flow chart illustrating implementation processing of the initial operation after the digital multifunction apparatus 1 of Embodiment 3 of the disclosure is started.

As illustrated in FIG. 15, after the digital multifunction apparatus 1 is started, in step S71, the controller 10 sets the pre-job implementation flag to ON (step S71).

Next, in step S72, the controller 10 implements a predetermined initial operation (step S32).

Next, in step S73, when the predetermined initial operation is completed (step S73), the controller 10 causes the apparatus to transition to the waiting state.

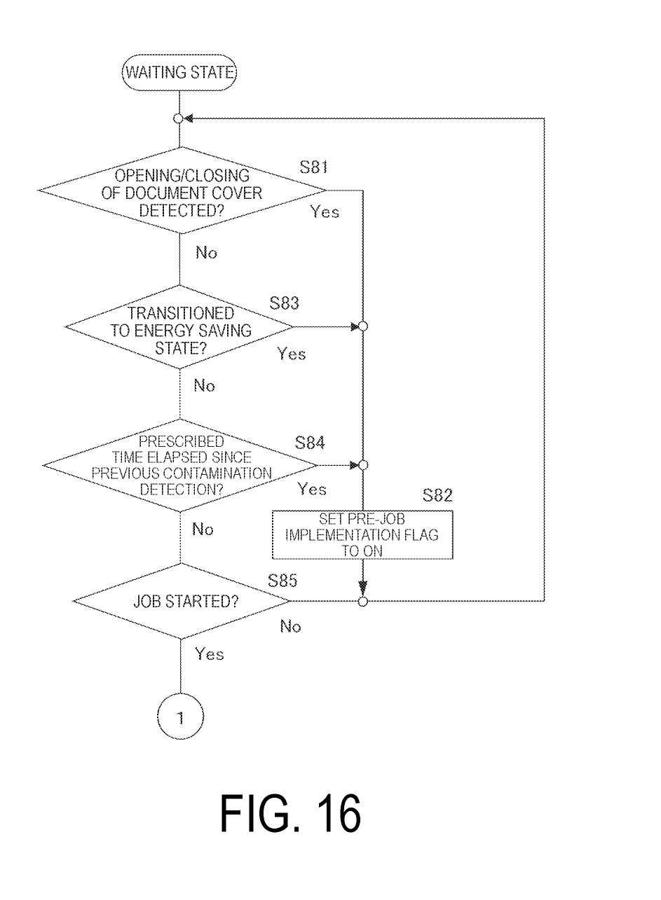

FIG. 16 is a flow chart illustrating job start determination processing in the waiting state for the digital multifunction apparatus 1 of Embodiment 3 of the disclosure.

As illustrated in FIG. 16, when the digital multifunction apparatus 1 is in the waiting state, in step S81, the controller 10 determines whether the document cover opening/closing detector 19 detects opening/closing of the document cover or not (step S81).

When the document cover opening/closing detector 19 detects opening/closing of the document cover (when the determination in step S81 is YES), in step S82, the controller 10 sets the pre-job implementation flag to ON (step S82).

Next, in step S85, the controller 10 determines whether a job is started or not (step S85).

When a job is started (when the determination in step S85 is YES), the controller 10 returns the processing to the determination in step S51 in FIG. 14.

On the other hand, when a job is not started (when the determination in step S85 is NO), the controller 10 returns the processing to the determination in step S81.

On the other hand, in step S81, when the document cover opening/closing detector 19 does not detect opening/closing of the document cover (when the determination in step S81 is NO), in step S83, the controller 10 determines whether the apparatus transitions to an energy saving state or not (step S83).

When the apparatus transitions to the energy saving state (when the determination in step S83 is YES), in step S82, the controller 10 sets the pre-job implementation flag to ON (step S82).

On the other hand, when the apparatus does not transition to the energy saving state (when the determination in step S83 is NO), in step S84, the controller 10 determines whether a predetermined prescribed time elapses after previous contamination detection or not (step S84).

The prescribed time may be set to any time as long as the time is shorter than a time for transitioning to the energy saving state. For example, when the time for transitioning to the energy saving state is 10 minutes, the prescribed time may be set to 5 minutes. Further, when the time for transitioning to the energy saving state is longer than 10 minutes, the prescribed time may be set to 10 minutes.

When the predetermined prescribed time elapses after the previous contamination detection (when the determination in step S84 is YES), in step S82, the controller 10 sets the pre-job implementation flag to ON (step S82).

On the other hand, when the predetermined prescribed time does not elapse after the previous contamination detection (when the determination in step S84 is NO), in step S85, the controller 10 determines whether a job is started or not (step S85).

In this way, since the contamination detector 18 is caused to detect contamination for the image data acquirer 11 when the predetermined contamination detection condition is satisfied before a job is started, it is possible to achieve the digital multifunction apparatus 1 capable of further appropriately coping with a change in the contamination state before a job is started, and accurately detecting contamination for the image data acquirer without causing a delay before a job is started as compared with the related art.

Preferred aspects of the disclosure include combinations of any of the multiple aspects described above.

Various modifications of the disclosure are also possible as well as the aforementioned embodiments. It should not be understood that the modifications do not belong to the scope of the disclosure. The disclosure shall include meanings equivalent to the scope of the claims and all modifications within the scope.

### Reference Signs List

1: Digital multifunction apparatus, 10: Controller, 11: Image data acquirer, 12: Image former, 13: Storage, 14: Image processor, 15: Communicator, 16: Feeder, 17: Operation panel, 18: Contamination detector, 19: Document cover opening/closing detector, 20: Timer, 111: Document reading glass, 112: Document placement glass, 113: Rail, 114: Drive belt, 115: Drive gear, 116: Document reading unit, 171: Display, 172: Operation acceptor

1. An image reading apparatus, comprising:
an operation acceptor that accepts a command from a user;
an image data acquirer that reads a document and acquires image data;
a contamination detector that detects contamination of the image data acquirer;
a storage that records a detection result of the contamination detector as contamination detection information;
a display that displays various types of information to the user; and
one or more controllers, wherein
in a case where the operation acceptor accepts a command to read the document, the one or more controllers refer to the contamination detection information recorded in the storage, and in a case where contamination is detected on the image data acquirer, cause the display to display a message about the contamination and an inquiry about whether to start reading of the document or not, and in a case where the operation acceptor accepts a command to start the reading of the document, cause the image data acquirer to start the reading of the document, and
on the other hand, in a case where contamination is not detected on the image data acquirer, the one or more controllers cause the image data acquirer to start the reading of the document.

2. The image reading apparatus according to claim 1, wherein
the one or more controllers, after the reading of the document is completed, cause the contamination detector to detect contamination of the image data acquirer, and to record a detection result in the storage as contamination detection information.

3. The image reading apparatus according to claim 1, wherein
the one or more controllers, after the reading of the document is completed, in a case where a predetermined contamination detection condition is satisfied, cause the contamination detector to detect contamination of the image data acquirer, and to record a detection result in the storage as contamination detection information.

4. The image reading apparatus according to claim 3, wherein
the one or more controllers determine that the contamination detection condition is satisfied in a case where the apparatus is started or transitions to a power saving state.

5. The image reading apparatus according to claim 3, wherein
the one or more controllers determine that the contamination detection condition is satisfied in a case where a predetermined time elapses from a previous detection time of contamination of the image data acquirer.

6. The image reading apparatus according to claim 3, wherein
the image data acquirer includes a document table on which the document is placed, a document cover, and an opening/closing detector of the document cover, and
the one or more controllers determine that the contamination detection condition is satisfied in a case where opening/closing of the document cover is detected.
